(19) United States
(12) Patent Application Publication
(10) Pub. No.: US 2006/0089444 A1
(43) Pub. Date: Apr. 27, 2006

(54) Flame retardant polymer compositions comprising a particulate clay mineral

(76) Inventors: Howard Goodman, Cornwall (GB); Anabelle Huguette Renee Legrix, Cornwall (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/508,830

(22) PCT Filed: Mar. 28, 2003
(86) PCT No.: PCT/GB03/01364

§ 371 Date: Aug. 3, 2005

(30) Foreign Application Priority Data
Mar. 28, 2002 (GB) 0207425.0
Apr. 25, 2002 (GB) 0209535.4

(51) Int. Cl. C08K 3/34

(52) U.S. Cl. 524/445

(57) ABSTRACT

A flame retardant polymer composition having acceptable char strength and optionally also drip resistance comprises a polymer and a particulate clay mineral distributed in the polymer composition at a particle number per unit volume of at least about 1 particle per 100 μm³, provided that the clay mineral present at the said particle number per unit volume is not an organomontmorillonite. The composition preferably further contains alumina trihydrate (ATH) and/or another flame retardant.

### FIELD OF THE INVENTION

The present invention relates to flame retardant polymer compositions, and particularly to such compositions which include particulate clay minerals. The invention also relates to particulate filler materials for the compositions, to process intermediates from which the compositions may be formed and to articles made from the compositions.

### BACKGROUND OF THE INVENTION

Flame retardant polymer compositions are widely used, particularly in locations where there is a risk of high temperatures and/or fire, or where the consequences of burning of the polymer composition would be catastrophic. For example, the sheathing or coating of electrical cables must meet legally specified flame retardancy standards, to limit the risk of failure of electrical systems in the event of a fire and to limit the risk of a fire being started or spread as a result of overheating of the cable by the electric current. The cable sheathing or coating will be rated to withstand a specified temperature.

Generally speaking, flame retardant polymer compositions include additives which can have one or more of the following effects on exposure of the composition to fire: (i) char promotion, in which the combusted composition forms a solid mass (“char”), which provides an insulating layer against the fire heat, inhibiting escape of volatile combustible materials from the composition and inhibiting inward diffusion of oxygen; (ii) imparting drip resistance, in which the tendency of a thermoplastic polymer to drip when heated is reduced; (iii) promotion of heat absorption, in which the additive removes heat from the system; and (iv) promotion of heat quenching, in which the additive inhibits combustion in the gas phase by interfering with the chemical reactions which spread and maintain a flame.

Known char forming additives include phosphorus-containing compounds, boron-containing compounds and metal salts such as alkali metal salts of sulphur-containing compounds, which can fuse and solidify at flame temperatures, thereby creating a ceramic-like or glass-like mass which structurally supports the char.

Known drip suppressing additives for thermoplastic polymers include polytetrafluoroethylene (PTFE). The PTFE is typically present at an amount of up to about 5% by weight of the total composition, and forms fibrils which stabilise the thermoplastic polymer under molten conditions. See, for example, WO-A-99/43747 and the prior publications referred to therein and in the search report thereon, the contents of which are incorporated herein by reference.

Known heat absorbing additives include metal hydroxides or hydrates such as alumina trihydrate (ATH; Al(OH)₃) or magnesium hydroxide (Mg(OH)₂). These additives are believed to work by absorbing heat to evaporate water contained in their structure.

Known heat quenching (flaming resistance) additives include free radical scavengers such as organic halogen-containing compounds such as brominated and chlorinated hydrocarbons. These additives are believed to work by releasing halogens into the flame, which inhibit combustion of the gas phase. Synergistic co-additives such as antimony oxide may be present, to enhance the heat quenching effects of the free radical scavengers. See, for example, U.S. Pat. No. 4,582,866 and the prior publications referred to therein and in the search report thereon, the contents of which are incorporated herein by reference.

The known additives are not entirely satisfactory, however, and the need for alternative and improved additives remains. For example, additives such as PTFE can adversely affect the surface finish of the composition. The use of halogen-containing compounds is believed to cause health problems and environmental damage. The additives can also adversely affect impact strength and impact resistance of the composition, or other physical properties. At the same time, cost pressures can urge that the level of additive used is as low as possible.

Proposals have been made to include certain clays as flame retardant additives in polymer compositions, in an attempt to answer some of these difficulties. WO-A-99/43747 and U.S. Pat. No. 4,582,866, referred to above, teach the inclusion of an organoclay, more specifically organomontmorillonite as a co-additive.

WO-A-01/46307, the disclosure of which is incorporated herein by reference, describes polypropylene, ABS (acrylonitrile-butadiene-styrene) copolymer, polystyrene and polyurethane compositions (all thermoplastic polymers) containing as flame retardant additive 5 or 10 parts by weight of a montmorillonite clay cation-exchanged with diethyl-di(hydrogenated tallow)-ammonium ion (Claytone HY), the polypropylene compositions containing either 10 parts by weight of the organoclay as sole flame retardant additive or 10 parts by weight of the organoclay together with antimony oxide and a brominated hydrocarbon selected from ethylene bis-tetrabromophthalidimide and decabromodiphenyloxide. It is reported (Table 1) that the compositions all show no dripping under the Underwriters Laboratories standard 94 (“UL 94”) vertical flame test (ASTM 3801), test specimens 0.062 inches (1.57 mm) thick.

U.S. Pat. No. 5,946,309, the disclosure of which is incorporated herein by reference, describes generally a coarse particle size kaolin clay product having an average equivalent particle diameter of about 4.5 to 6.0 microns (μm) as measured using a Micromeritics Sedigraph 5100 unit, and a BET surface area of about 8 to 11 m²/g, and its use as a filler for polymeric compositions. The preferred product is stated to have a high aspect ratio, preferably of about 12 to 14 as determined by Sphericity Model calculations from experimentally determined surface area data according to the method described in U.S. Pat. No. 5,167,707 and the references cited therein (the contents of which are also incorporated herein by reference).

U.S. Pat. No. 5,846,309 specifically describes (Examples 6 and 7) a paste for making a moulded thermoset unsaturated polyester resin having a styrene content of about 33% (Aristech Resin MR 13017) containing a kaolin/ATH filler at a filler loading of 100 phr (i.e. 50:50 weight percent polymer:filler). The kaolin had an equivalent particle diameter of 5.25 μm and an aspect ratio (Sphericity Model) of 13.1 (see Table 1-C). The two ATHs used had BET surface areas of 0.24 and 2.0 m²/g (Table 6). The weight ratio of the kaolin to the ATH varied from 100:0 to 0:100 (FIGS. 3 and 4). The paste compositions were tested for viscosity, to determine whether the presence of the clay assisted or hindered processing of the paste. The pastes were not set and flame retardancy of the resin was therefore not tested. Indeed, it was left open whether the filler material would or would not adversely affect the physical properties of the thermoset composite (column 22, line 60 to 67). It was reported that the presence of the clay generally increased the paste viscosity, which is undesirable for processing. It was stated (column 24, lines 7 to 13) that one must carefully balance the flame retardancy plus the viscosity reduction and specific gravity reduction benefits of ATH use against the increased cost and reduced surface finish disadvantages in a given application to achieve the best cost versus performance properties.

The present invention is based on the surprising finding that, by using a particulate clay filler at a high number of clay mineral particles per unit volume in the polymer composition, or a high aspect ratio particulate kaolin having an average particle diameter less than about 4 μm in a filler component of a polymer composition, or a particulate clay mineral filler which fulfils both requirements, an acceptable degree of char strength can be obtained, optionally together with drip resistance, while substantially preserving general desirable physical properties of the polymer compositions.

### BRIEF DESCRIPTION OF THE INVENTION

According to the present invention in a first aspect, there is provided a flame retardant polymer composition comprising a polymer and a particulate clay mineral distributed in the polymer composition at a particle number per unit volume of at least about 1 particle per 100 μm³, provided that the clay mineral present at the said particle number per unit volume is not an organomontmorillonite.

In embodiments of the invention, the particle number per unit volume is at least about 2 particles per 100 μm³, for example at least about 5 particles per 100 μm³, for example at least about 8 particles per. 100 μm³ , for example at least about 10 particles per 100 μm³, for example at least about 15 particles per 100 μm³ or at least about 20 particles per 100 μm³.

Normally, in compositions of this aspect of the invention, the particle number per nit volume in the polymer composition till be no greater than about 10,000 particles per 100 μm³.

The clay mineral may be selected from kaolin clays and non-kaolin clay minerals. Kaolin clays are preferred.

As stated above, the clay mineral present at the said particle number per unit volume is not an organomontmorillonite. In embodiments of the invention, the clay mineral is not an organoclay of any type.

The particulate kaolin clay, when used, will preferably have a mean equivalent particle diameter less than or equal to about 4 microns (μm), e.g. less than 4.5 μm, particularly less than 4.0 μm, and a particle shape factor which is greater than about 10, e.g. greater than about 30, particularly at least about 60, particularly at least about 70, particularly at least about 90, most particularly at least about 100, e.g. at least about 120, and preferably up to about 150.

According to the present invention in a second aspect, there is provided a flame retardant polymer composition comprising a polymer and a particulate kaolin clay having a mean equivalent particle diameter less than or equal to about 4 microns (μm), e.g. less than 4.5 μm, particularly less than 4.0 μm, and a particle shape factor which is greater than about 10, e.g. greater than about 30, particularly at least about 60, particularly at least about 70, particularly at least about 90, most particularly at least about 100, e.g. at least about 120, and preferably up to about 150.

The composition may suitably include one or more further non-kaolin components, which may be selected from one or more conventional flame retardant component, one or more conventional non-flame retardant component, or both. Any non-kaolin component will suitably be present in a smaller weight proportion than the essential components of the composition. The essential components of the composition preferably constitute the majority (i.e. over half) of the weight of the composition.

The conventional flame retardant component, when present, may, for example, be selected from phosphorus-containing compounds, boron-containing compounds, metal salts, metal hydroxides, metal oxides, hydrates thereof, organoclays (including ion-exchanged and any other modified organoclays), halogenated hydrocarbons, and any combination thereof, typically boric acid, a metal borate and any combination thereof. A preferred flame retardant component is ATH.

The conventional non-flame retardant component, when present, may, for example, be selected from pigments, colorants, anti-degradants, anti-oxidants, impact modifiers, inert fillers, slip agents, antistatic agents, mineral oils, stabilisers, flow enhancers, mould release agents, nucleating agents, clarifying agents, and any combination thereof.

According to the present invention in a third aspect, there is provided a particulate filler material for a flame retardant polymer composition, the filler material comprising a mixture of a particulate flame retardant (for example, ATH) and a particulate kaolin clay, wherein the particulate kaolin clay has a mean equivalent particle diameter less than or equal to about 4 microns (μm) and a particle shape factor which is greater than about 10, e.g. greater than about 30. The particulate filler material may further comprise one or more additional non-kaolin flame retardant component and/or one or more non-kaolin non-flame retardant component.

For processing to form the polymer composition, the components will preferably be mixed, the polymer component being present as liquid or particulate solid, optionally as one or more precursor(s) of the polymer component. Such a process and the resultant mixture constitute respectively fourth and fifth aspects of the present invention.

According to the present invention in a sixth aspect, there is provided an article, for example an electrical product or other article comprising a sheath, coating or housing, formed from a flame retardant polymer composition according to the first or second aspect of the present invention.

### DETAILED DESCRIPTION OF THE INVENTION

Particulate Kaolin and Particulate Non-Kaolin Clay Minerals

The particulate kaolin may comprise hydrous kaolin, partially calcined kaolin (metakaolin), fully calcined kaolin, ball clay or any combination thereof. The kaolin clay is preferably a hydrous kaolin. Mixtures of different kaolins and/or non-kaolin clay minerals may be used, provided that the particulate kaolin/non-kaolin clay mineral has the required mean equivalent particle diameter and the required shape factor.

A clay mineral e.g. kaolin product of high shape factor is considered to be more “platey” than a kaolin product of low shape factor. “Shape factor” as used herein is a measure of an average value (on a weight average basis) of the ratio of mean particle diameter to particle thickness for a population of particles of varying size and shape as measured using the electrical conductivity method and apparatus described in GB-A-2240398/U.S. Pat. No. 5,128,606/EP-A-0528078 and using the equations derived in these patent specifications. “Mean particle diameter” is defined as the diameter of a circle which has the same area as the largest face of the particle. In the measurement method described in EP-A-0528078 the electrical conductivity of a fully dispersed aqueous suspension of the particles under test is caused to flow through an elongated tube. Measurements of the electrical conductivity are taken between (a) a pair of electrodes separated from one another along the longitudinal axis of the tube, and (b) a pair of electrodes separated from one another across the transverse width of the tube, and using the difference between the two conductivity measurements the shape factor of the particulate material under test is determined.

The “aspect ratio” parameter of the kaolin clay product of the prior art U.S. Pat. No. 5,946,309 is not numerically the same as the “shape factor” parameter of the kaolin used in the present invention. For example, for one clay which we have tested, it is found experimentally that an “aspect ratio” of 9 according to the prior art determination corresponds to a “shape factor” according to the present invention of about 65±5. Therefore, it is believed that a particulate kaolin having an “aspect ratio” of greater than 9 according to the prior art determination will probably fulfil the requirement of “shape factor” according to the present invention. However, since the average equivalent particle diameter of the kaolin used in the present invention is clearly different from that of the kaolin used in the prior art patent the determination methods for this parameter being the same as between the prior art patent and the present invention, the products are different and an attempt to correlate aspect ratio with shape factor between such different materials has not been made.

The mean (average) equivalent particle diameter (d₅₀ value) and other particle size properties referred to herein for the clay minerals including the particulate kaolin are as measured in a well known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (esd), less than given esd values. The mean particle size d₅₀ is the value determined in this way of the particle esd at which there are 50% by weight of the particles which have an equivalent spherical diameter less than that d₅₀ value.

The value of d₅₀ for the particulate kaolin is less than or equal to about 4 μm, (by Sedigraph) e.g. less than or equal to about 3 μm. It may, for example, be in the range of about 0.1 μl gm to about 3 μm for example about 0.1 μl gm to about 1.5 or 2 μm, or in the range 0.4 μm to about 3 μm, especially 0.5 μm to about 2 μm. For example, particulate kaolin of English (Cornish) origin may have a d₅₀ value of from 0.5 μm to 1.5 μm.

In the case of particulate clay minerals present in the polymer composition at a relatively high number of particles per unit volume, the value of d₅₀ will generally be relatively low, to provide the required particle number.

The particulate kaolin or other clay according to the invention may be prepared by light comminution, e.g. grinding or milling, of a coarse kaolin to give suitable delamination thereof. The comminution may be carried out by use of beads or granules of a plastics, e.g. nylon, grinding or milling aid. The coarse kaolin may be refined to remove impurities and improve physical properties using well known procedures. The kaolin or other clay may be treated by a known particle size classification procedure, e.g. screening and/or centrifuging, to obtain particles having a desired d₅₀ value.

A range of particulate kaolins and other clay minerals are available, which have the required particle size and shape factor, or can easily be processed in ways well known to the skilled worker to arrive at the required particle size and shape factor. One suitable particulate kaolin for use in the present invention has a mean equivalent particle diameter of about 1.3 μm and a shape factor in the range of about 120 to about 150. It typically also has a specific gravity of about 2.6 g/cm³, a specific surface area of about 11 m²/g as measured by the BET nitrogen absorption method, a brightness (ISO) of about 89, a chemical analysis (by X-ray fluorescence) of 46.4% SiO₂ and 38.4% Al₂O₃, and a particle size distribution such that a maximum of 3% by weight of the particles have a size greater than 10 μm and a minimum of 67% by weight of the particles have a size less than 2 μm.

The kaolin or other clay mineral is suitably present in the polymer composition according to the present invention at amounts in the general loading range between about 10 and about 150 parts by weight per hundred of polymer, and more preferably between about 10 and about 100 parts per hundred.

Where the clay mineral is a non-kaolin clay mineral, this may be selected from any of the known non-kaolin clay minerals. These include those clay minerals referred to in Chapter 6 of “Clay Colloid Chemistry” by H. van Olphen, (Interscience, 1963); more specifically they include: montmorillonoids such as montmorillonite, talc, pyrophilite, hectorite and vermiculite; illites; other kaolinites such as dickite, nacrite and halloysite; chlorites; attapulgite and sepiolite.

Particle Number Per Unit Volume

The parameter of particle number per unit volume (referred to herein as N_{per unit volume} or Nₚᵤᵥ) is calculated from the d₅₀ of the clay by Sedigraph (d) and the volume fraction of the clay in the polymer composition (φ), according to the following relationship:

$${N}_{puv} = \frac{6}{π} \frac{ϕ}{{d}^{3}}$$

Here, d, measured by the Sedigraph is related to both the average diameter of the clay (mineral) disk or platelet (D) and the shape factor NSF as follows:

$$d = D \sqrt{\frac{3}{2} \frac{arctan NSF}{NSF}}$$

(see Jennings et al, Particle size measurement: the equivalent spherical diameter, Proc. R. Soc. Lond., A419, 137-149, 1988).

Polymer

The polymer comprises any natural or synthetic polymer or mixture thereof. The polymer may, for example, be thermoplastic or thermoset. The term “polymer” used herein includes homopolymers and copolymers, as well as crosslinked and/or entangled polymers and elastomers such as natural or synthetic rubbers and mixtures thereof. Specific examples of suitable polymers include, but are not limited to, polyolefins of any density such as polyethylene and polypropylene, polycarbonate, polystyrene, polyester, acrylonitrile-butadiene-styrene copolymer, nylons, polyurethane, ethylene-vinylacetate polymers, and any mixture thereof, whether cross-inked or un-cross-linked.

The term “precursor” as applied to the polymer component will be readily understood by one of ordinary skill in the art. For example, suitable precursors may include one or more of: monomers, cross-linking agents, curing systems comprising cross-lining agents and promoters, or any combination thereof. Where according to the invention the particulate clay mineral, e.g. kaolin clay, is mixed with precursors of the polymer, the polymer composition will subsequently be formed by curing and/or polymerising the precursor components to form the desired polymer.

Flame Retarding Component

As stated above, the polymer composition according to the present invention may suitably contain one or more non-kaolin flame retarding additives. Such additives may, for example, be selected from one or more of the following:

(i) One or more char promoter;

(ii) One or more drip suppressant;

(iii) One or more heat absorber; and

(iv) One or more heat quencher (ignition suppressant).

Any conventional such additives may be used, as will be apparent to one of ordinary skill in this art. Examples of such additives include:

Char Promoters and Drip Suppressants

Phosphorus-containing compounds (e.g. organophosphates or phosphorus pentoxide), boron-containing compounds (e.g. boric acid and metal borates such as sodium borate, lithium metaborate, sodium tetraborate or zinc borate), organoclays (e.g. smectite clays such as bentonite, montmorillonite, hectorite, saponite and ion-exchanged forms thereof, suitably ion-exchanged forms incorporating cations selected from quaternary ammonium and alkylimidazolium ions), metal oxides (e.g. lead dioxide);

Heat Absorbers

Metal salts, metal hydroxides (e.g. ATH, magnesium hydroxide), hydrates thereof (e.g. sodium tetraborate decahydrate);

Heat Quenchers

Halogenated hydrocarbons (e.g. halogenated carbonate oligomers, halogenated phenyl oxides, halogenated alkylene-bis-phthalidimides and halogenated diglycyl ethers), optionally together with metal oxides (e.g. antimony oxide).

The non-kaolin or non-clay flame retarding component, when present, is suitably present in the polymer composition or the filler material according to the present invention at amounts between about 5 and about 70% by total weight of the kaolin or other clay and non-kaolin/non-clay flame retarding components, and more preferably between about 5 and about 50% by weight.

Non-Flame Retarding Component

The polymer composition may include one or more. non-kaolin or non-clay non-flame retardant additives for polymers, for example selected from pigments, colorants, anti-degradants, anti-oxidants, impact modifiers (e.g. core-shell graft copolymers), fillers (e.g. talc, mica, wollastonite, glass or a mixture thereof), slip agents (e.g. erucamide, oleamide, linoleamide or steramide), coupling agents (e.g. silane coupling agents), peroxides, antistatic agents, mineral oils, stabilisers, flow enhancers, mould release agents (e.g. metal stearates such as calcium stearate and magnesium stearate), nucleating agents, clarifying agents, and any combination thereof.

The non-kaolin/non-clay non-flame retarding component, when present, is suitably present in the polymer composition or the filler material according to the present invention at amounts up to about 50% by total weight of the kaolin and, if present, non-kaolin flame retarding component, and more preferably between up to about 30% by weight.

The coupling agent, where present, serves to assist binding of the filler particles to the polymer. Suitable coupling agents will be readily apparent to those skilled in the art. Examples includes silane compounds such as, for example, tri-(2-methoxyethoxy) vinyl silane. The coupling agent is typically present in an amount of about 0.1 to about 2% by weight, preferably about 1% by weight, based on the weight of the total particulate filler.

Preparation of the Compositions

Preparation of the polymer compositions of the present invention can be accomplished by any suitable mixing method known in the art, as will be readily apparent to one of ordinary skill in the art.

Such methods include dry blending of the individual components or precursors thereof and subsequent processing in conventional manner.

In the case of thermoplastic polymer compositions, such processing may comprise melt mixing, either directly in an extruder for making an article from the composition, or pre-mixing in a separate mixing apparatus such as a Banbury mixer. Dry blends of the individual components can alternatively be directly injection moulded without pre-melt mixing.

The filler material according. to the third aspect of the present invention can be prepared by mixing of the components thereof intimately together. The said filler material is then suitably dry blended with the polymer and any desired additional components, before processing as described above.

For the preparation of cross-linked or cured polymer compositions, the blend of uncured components or their precursors, and, if desired, the clay, for example kaolin, and any desired non-kaolin/non-clay component(s), will be contacted under suitable conditions of heat, pressure and/or light with an effective amount of any suitable cross-linking agent or curing system, according to the nature and amount of the polymer used, in order to cross-link and/or cure the polymer.

For the preparation of polymer compositions where the clay, for example kaolin, and any desired non-kaolin component(s) are present in situ at the time of polymerisation, the blend of monomer(s) and any desired other polymer precursors, clay, for example kaolin and any non-kaolin component(s) will be contacted under suitable conditions of heat, pressure and/or light, according to the nature and amount of the monomer(s) used, in order to polymerise the monomer(s) with the clay, for example kaolin and any desired non-kaolin component(s) in situ.

Articles

The polymer compositions can be processed to form, or to be incorporated in, articles of commerce in any suitable way. Such processing may include compression moulding, injection moulding, gas-assisted injection moulding, calendaring, vacuum forming, thermoforming, extrusion, blow moulding, drawing, spinning, film forming, laminating or any combination thereof. Any suitable apparatus may be used, as will be apparent to one of ordinary skill in this art.

The articles which may be formed from the compositions are many and various. Examples include sheaths for electrical cables, electrical cables coated or sheathed with the polymer composition, and housings and plastics components for electrical appliances (e.g. computers, monitors, printers, photocopiers, keyboards, pagers, telephones, mobile phones, hand-held computers, network interfaces, plenums and televisions).

### BRIEF DESCRIPTION OF THE DRAWINGS

Embodiments of the present invention will now be described, purely by way of example and without limitation, with reference to the later Examples and with reference to the accompanying drawings, in which:

FIG. 1 shows graphs of shear viscosity on a logarithmic vertical axis (Pa·s) plotted against shear rate on a logarithmic horizontal axis (s⁻¹), for (a) two polymer compositions according to the present invention and (b) two control compositions not including any mineral filler;

FIG. 2 shows a graph of shear viscosity on a logarithmic vertical axis (Pa·s) plotted against shear rate on a logarithmic horizontal as (s⁻¹), for two further polymer compositions according to the present invention, as well as the same compositions as shown in FIG. 1(b);

FIG. 3 shows a graph of char strength plotted against Number of particles per unit volume for certain polymer compositions according to the present invention;

FIG. 4 shows a graph of heat release rate (kW/m²) plotted against time (s) for certain polymer compositions according to the present invention

FIG. 5 shows a graph of specific extinction area (m²/kg) (representative of the extent of smoke production) plotted against time (s) for certain polymer compositions according to the present invention;

FIG. 6 shows a graph of CO and CO₂ emission (kg/kg) against time (s) for certain polymer compositions according to the present invention; and

FIG. 7 shows a graph of ignition time (s) plotted against Number of particles per unit volume for certain polymer compositions according to the present invention.

### DETAILED DESCRIPTION OF THE DRAWINGS AND EXAMPLES

Preparation of Test Materials

The following Examples illustrate the preparation of the test materials embodying the present invention and the comparison and control materials.

“Platey” Clay

A powdered platey kaolin clay (designated Clay A) was used in some of the Examples. Clay A had a mean equivalent particle diameter of about 1.3 μm; a shape factor in the range of about 120 to about 150; a specific gravity of about 2.6 g/cm³; a specific surface area of about 1.1 m²/g as measured by the BET nitrogen absorption method; a brightness (ISO) of about 89; a chemical analysis (by X-ray fluorescence) of 46.4% SiO₂ and 38.4% Al₂O₃; and a particle size distribution such that a maximum of 3% by weight of the particles have a size greater than 10 μm and a minimum of 67% by weight of the particles have a size less than 2 μm.

Other Clays

A number of other clays, designated Clays B to M, were also used in some of the Examples. Their chemical analysis data (by X-ray fluorescence) are set out in Table 1a below. Table 1b shows data relating to the mean equivalent particle diameter and shape factor, as well as corresponding data relating to the ATH co-filler used in the polymer compositions. Clays A to J are particulate hydrous kaolin clays. Clays K to M are particulate fully calcined kaolin clays. Clay N is a particulate talc.

Clays A to N are all available commercially, or can readily be prepared from commercially available materials.

TABLE 1a

| | XRF chemical analysis (wt %) | | | | | | | | Loss on |
|---|---|---|---|---|---|---|---|---|---|
| Clay | SiO₂ | Al₂O₃ | Fe₂O₃ | TiO₂ | CaO | MgO | K₂O | Na₂O | Ignition |
| A | 46.4 | 38.46 | 0.32 | 0.01 | 0.02 | 0 | 1.39 | 0.19 | 13.01 |
| B | 49.4 | 35.58 | 0.95 | 0.08 | 0.05 | 0.25 | 2.43 | 0.09 | 11.17 |
| C | 48.1 | 36.81 | 0.87 | 0.03 | 0.06 | 0.24 | 2.1 | 0.09 | 11.71 |
| D | 48.98 | 35.87 | 0.84 | 0.03 | 0.1 | 0.24 | 1.72 | 0.09 | 12.12 |
| E | 47.36 | 37.04 | 0.57 | 0.56 | 0.04 | <0.01 | 0.11 | 0.12 | 14.22 |
| F | 48.49 | 36.54 | 0.42 | 0 | 0.06 | 0.23 | 1.28 | 0.12 | 18.85 |
| G | 48.35 | 36.7 | 0.69 | 0.03 | 0.04 | 0.21 | 1.18 | 0.09 | 12.79 |
| H | | | | | N/A | | | | |
| I | 55.97 | 29.17 | 1.24 | 0.98 | 0.18 | 0.42 | 2.76 | 0.4 | 8.88 |
| J | 48.59 | 35.44 | 0.8 | 0.02 | 0.09 | 0.34 | 1.07 | 0.1 | 13.55 |
| K | 56.72 | 38.98 | 0.6 | <0.01 | 0.06 | 0.29 | 2.71 | 0.16 | 0.49 |
| L | 52.8 | 44.14 | 0.9 | 1.38 | 0.08 | 0.06 | 0.1 | 0.13 | 0.4 |
| M | 54.71 | 40.34 | 0.87 | 0.06 | 0.07 | 0.4 | 1.42 | 0.26 | 1.86 |
| N | 62.7 | <0.01 | 0.64 | <0.01 | 0.1 | 34.62 | <0.01 | <0.01 | 6.1 |

TABLE 1b

| | | d50 | Sedigraph % below (μm) | | | | | | |
|---|---|---|---|---|---|---|---|---|---|
| Filler | NSF | (μm) | 10 | 5 | 2 | 1 | 0.75 | 0.5 | 0.25 |
| Superfine SF7 | 3 | 0.8 | 96.0 | 95.1 | 90.2 | 70.4 | 43.7 | 11.1 | <5% |
| ATH | | | | | | | | | |
| A | 130 | 1.28 | 98.3 | 94.2 | 69.4 | 40.8 | 30.5 | 18.4 | 6.8 |
| B | 70 | 1.61 | 93.9 | 83.7 | 52.6 | 34.2 | 27.7 | 18.7 | 10.2 |
| C | 32 | 1.04 | 98.2 | 92.4 | 63.1 | 47.1 | 40.9 | 31.8 | 15.3 |
| D | 23 | 0.6 | 99.6 | 98.1 | 80.7 | 64.6 | 57.3 | 45.6 | 24 |
| E | 28 | 0.61 | 99.9 | 99.7 | 90.9 | 69.3 | 57.3 | 40 | 16.1 |
| F | 15 | 0.51 | 98.8 | 97.9 | 83.8 | 69 | 61.9 | 49.5 | 27.1 |
| G | 25 | 0.41 | 99.4 | 98.9 | 92.6 | 80.3 | 72.1 | 56.8 | 30.4 |
| H | 35 | 0.2 | | | | | | | |
| I | 13 | 0.22 | 98.4 | 95.4 | 84.9 | 76.9 | 73.5 | 67.6 | 49.3 |
| J | 25 | 0.12 | >99 | 99 | 97.8 | 97.6 | 97.8 | 96.8 | 81.5 |
| K | 3 | 2 | 96.6 | 86.8 | 50.1 | 20.8 | 12.1 | 5.6 | <5% |
| L | 3 | 0.5 | 99.1 | 97.3 | 92.1 | 84.9 | 76.1 | 49.7 | 7.3 |
| M | 3 | 0.31 | 99.4 | 99.1 | 98.2 | 96.6 | 94.1 | 81.1 | 32.5 |
| Talc - N | 22 | 1.8 | | | | | | | |
| Claytone ™ AF | 1000* | 0.5* | | | | | | | |

*estimated

Silane

The silane used in the Examples below was tri-(2-methoxyethoxy)vinyl silane.

### Examples 1 to 4

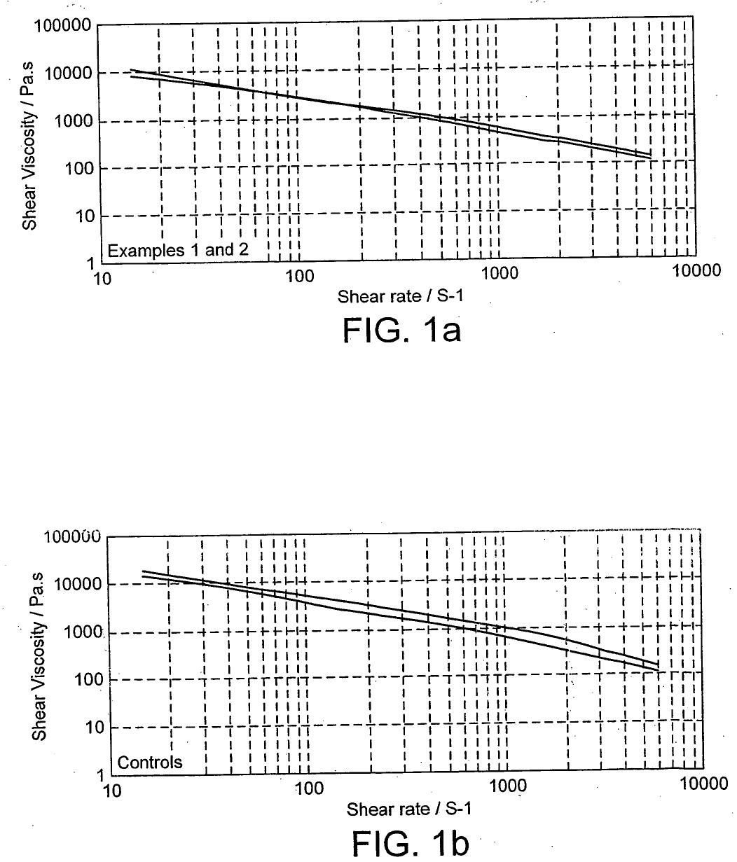

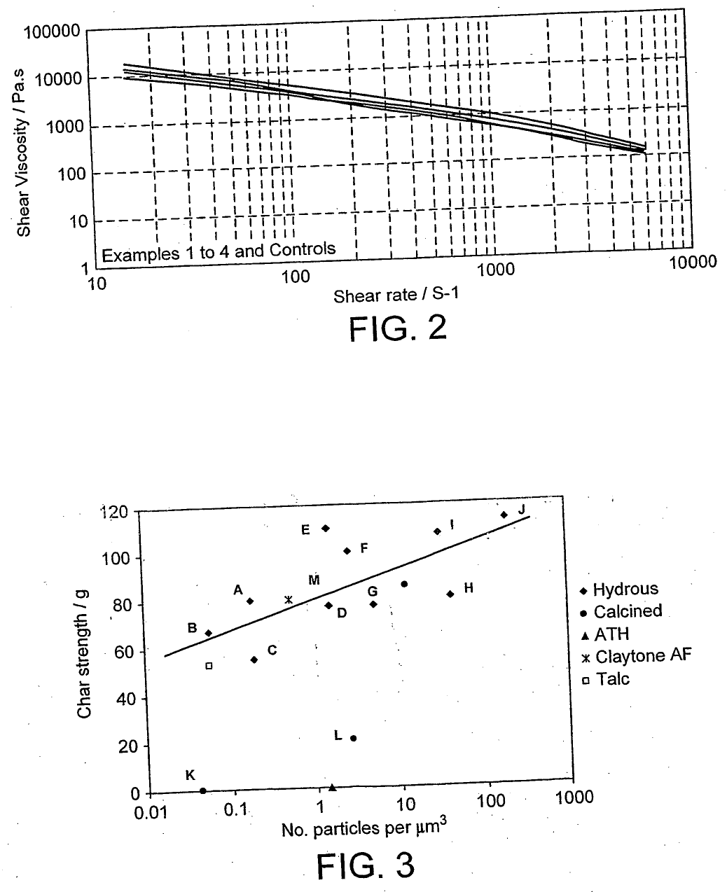

The materials used for FIG. 1(a) and included also in FIG. 2 were prepared by compounding the following thermoplastic polymers with Clay A at a loading of 61% clay by total weight of the composition: Example 1 used Escorene UL0019; an ethylene-vinylacetate copolymer available from Exxon Corporation, and the composition also contained 2% by weight of AC400, which is an ethylene-vinylacetate co-polymer (available from Honeywell), as a plasticiser; Example 2 used Clearflex Linear Low Density Polyethylene (CLDO), available from Polimeri Europa, and the composition also contained 2% by weight of AC6, which is a polyethylene homopolymer (available from Honeywell), as a plasticiser. A conventional Brabender mixer was used for the compounding.

The composition of Example 3, one of the further compositions according to the invention included in FIG. 2, was prepared by compounding Escorene UL0019 with a 50:50 by weight mixture of powdered ATH and Clay A at a total filler loading of 61% filler by total weight of the composition. A conventional Brabender mixer was used for the compounding.

The composition of Example 4, the final composition according to the invention included in FIG. 2, was prepared by compounding CLDO with a 50:50 by weight mixture of powdered ATH and Clay A at a total filler loading of 61% filler by total weight of the composition. A conventional Brabender mixer was used for the compounding.

The control materials used for FIG. 1(b) and included also in FIG. 2 were the unfilled Escorene UL0019 and Clearflex polymers each containing 2% of the respective plasticiser. A conventional Banbury mixer was used for the compounding.

The ATH grade used in the examples was Superfine SF7 available from Alcan.

### Comparative Examples C1 and C2 and Examples 5 to 11

Example 3 was repeated, but replacing the following proportions of ATH:Clay A for the 50:50 ratio previously described.
Comparative Example C1: Escorene UL0019+2% AC400+61% ATH;
Example 5: Escorene UL0019+2% AC400+61% filler (90:10 by weight ATH:Clay A);
Example 6: Escorene UL(0019+2% AC400+61% filler (70:30 by weight ATH:Clay A);
Example 7: Escorene UL0019+2% AC400+61% filler (60:40 by weight ATH:Clay A);
Example 8: Escorene UL0019+2% AC400+61% filler (40:60 by weight ATH:Clay A).
Example 9: Escorene UL0019+2% AC400+61% filler (30:70 by weight ATH:Clay A),.
Example 10: Escorene UL0019+2% AC400+61% filler (50:30:20 by weight Clay A:ATH:zinc borate);
Example 11: Escorene UL0019+2% AC400+61%. filer (30:70 by weight zinc borate:Clay A);
Comparative Example C2: Escorene UL0019+2% AC400+61% filler (5:95 by weight Claytone™ AF organoclay (from Southern Clay Products):ATH).

### Comparative Examples C3 and C4 and Examples 12 to 18

Example 4 was repeated, but replacing the following proportions of ATH:Clay A for the 50:50 ratio previously described.
Comparative Example C3: CLDO+2% AC400+61% ATH;
Example 12: CLDO+2% AC400+61% filler (90:10 by weight ATH:Clay A);
Example 13: CLDO+2% AC400+61% filler (70:30 by weight ATH:Clay A);
Example 14: CLDO+2% AC400+61% filler (60:40 by weight ATH:Clay A);
Example 15: CLDO+2% AC400+61% filler (40:60 by weight ATH:Clay A);
Example 16: CLDO+2% AC400+61% filler (30:70 by weight ATH:Clay A);
Example 17: CLDO+2% AC400+61% filler (50:30:20 by weight Clay A:ATH: zinc borate);
Example 18: CLDO+2% AC400+61% filler (30:70 by weight zinc borate:Clay A);
Comparative Example C4: CLDO+2% AC400+61% filler (5:95 by weight Claytone™ AF organoclay:ATH).
   Test Methods
   Viscosity Measurements

Viscosity measurements of the polymer compositions of Examples 1 to 4 and the controls were carried out using a Rosand capillary extrusion rheometer at 130° C. and speeds sequence of 200, 50, 20, 10, 5, 2, 1, 0.5, 1, 2, 5, 10, 20, and 50. The results are shown in FIGS. 1 and 2 of the drawings.

Char Strength Measurements

Qualitative assessments of char strength and form were made of the polymer compositions of Examples 1 to 18, and Comparative Examples C1 and C3, after completion of the flammability test (see below). The results are shown in Tables 2 and 3.

Underwriters Laboratories Standard UL94 Flammability Test (ASTM 3801)

The UL94 flammability test protocol was performed on 150×10×1 mm test samples of the polymer compositions of Examples 1 to 18, and Comparative Examples C1 and C3.

According to this test protocol, the test samples were clamped in a vertical position. The lower end was positioned 300 mm above a cotton wool pad and ignited with a Bunsen burner blue flame of 20 mm height. The flame was applied for 10 sec and the burning properties were recorded and reported in Tables 2 and 3 below (columns headed “Flame time to clamp” (the time taken in seconds, for the flame to reach the clamp); “Flame Dripping” (whether the polymer composition dripped during burning); “Cotton Ignition” (whether the cotton wool pad was ignited by any dripping polymer); “Char Strength” (a visual assessment of the nature and strength of any char); “V rating” (a flammability rating according to the test method; the assigned V rating in Tables 2 and 3 is not authoritative, as the test sample dimensions were smaller than the prescribed dimensions in the standard test (13 mm width)). The results are shown in Tables 2 and 3.

Oxygen Index (British Standard 2782, Part I, Method 141B: 1986)

The oxygen index test was carried out on 70×4×2 mm test samples of the polymer compositions of Examples 1 to 4, as well as Comparative Examples C1 and C3. The test used an oxygen index machine, which measured the minimum concentration of oxygen in a flowing mixture of oxygen and nitrogen that just supported flaming combustion of the burning polymer. The test samples were clamped in a vertical position inside the glass chimney of the machine and ignited and burnt from top downward. The oxygen index (OI) is expressed in terms of this oxygen concentration and values for the above compositions are reported in Tables 2 and 3.

Tensile Strength

The tensile strength of the polymer compositions was measured in conventional manner. The data (expressed in MPa) are shown in Tables 2 and 3.

Elongation

The percentage elongation at breaking was measured in conventional manner on the polymer compositions. The results are shown in Tables 2 and 3.

TABLE 2

| | | | | | | | Mechanical | |
|---|---|---|---|---|---|---|---|---|
| Fire properties | | | | | | | Properties | |
| | Flame time | | | | | Oxygen | Tensile | |
| | to the clamp | Flame | Cotton | Char | V | Index | strength | Elongation |
| Composition | (sec) | Dripping | ignition | Strength | rating | (OI) | MPa | (%) |
| C1 | 104 | Yes | Yes | Ash | 2 | 29 | 11 | 86 |
| Example 5 | 120 | Yes | Yes | Soft shell | 2 | N/a | 12.59 | 82.8 |
| Example 6 | 130 | Yes | Yes | Soft shell | 2 | N/a | 13.41 | 47.16 |
| Example 7 | 100 | Yes | Yes | Soft shell | 2 | N/a | 13.60 | 35.44 |
| Example 3 | 115 | Yes | Yes | Soft shell | 2 | 27 | 14 | 32 |
| Example 8 | 90 | Yes | Yes | Soft shell | 2 | N/a | 16.03 | 22.74 |
| Example 9 | 100 | Yes | Yes | Soft shell | 2 | N/a | 14.72 | 20.80 |
| Example 1 | 112 | NO | NO | Soft shell | 2 | 23 | 14 | 13 |
| Example 10 | 110 | Yes | Yes | Soft shell | 2 | N/a | 12.94 | 28.43 |
| Example 11 | N/a | N/a | N/a | N/a | N/a | N/a | 14.18 | 29.95 |
| C2 | N/a | N/a | N/a | N/a | N/a | N/a | 9.39 | 66.6 |

TABLE 3

| | | | | | | | Mechanical | |
|---|---|---|---|---|---|---|---|---|
| Fire properties | | | | | | | Properties | |
| | Flame time | | | | | Oxygen | Tensile | |
| | to the clamp | Flame | Cotton | Char | V | Index | strength | Elongation |
| Composition | (sec) | Dripping | ignition | Strength | rating | (OI) | MPa | (%) |
| C3 | 148 | Yes | Yes | Ash | 2 | 29 | 9 | 94 |
| Example 12 | 128 | Yes | Yes | Soft shell | 2 | N/a | 9.81 | 77 |
| Example 13 | 154 | Yes | Yes | Soft shell | 2 | N/a | 9.8 | 37.1 |
| Example 14 | 125 | Yes | Yes | Soft shell | 2 | N/a | 9.48 | 31.89 |
| Example 4 | 135 | NO | NO | Soft shell | 2 | 25 | 10 | 27 |
| Example 15 | 120 | NO | NO | Soft shell | 2 | N/a | 9.08 | 17.50 |
| Example 16 | 120 | NO | NO | Soft shell | 2 | N/a | 9.76 | 25.32 |
| Example 2 | 133 | NO | NO | Soft shell | 2 | 23 | 8 | 23 |
| Example 17 | 120 | Yes | Yes | Soft shell | 2 | N/a | 9.47 | 24.68 |
| Example 18 | 90 | Yes | Yes | N/a | 2 | N/a | 9.03 | 15.60 |
| C4 | N/a | N/a | N/a | N/a | N/a | N/a | 5.82 | 31.63 |

### Example 19

The polymer formulation used in this Example is shown in Table 4 below:

TABLE 4

| | | phr | |
|---|---|---|---|
| Material | Role | (active) | wt % |
| Escorene UL00119 | EVA resin | 100 | 37.84 |
| Filler (ATH and/or clay) | Flame Retardant Filler | 160 | 60.54 |
| Irganox 1010 | Antioxidant | 1 | 0.38 |
| Perkadox BC40-40MB-gr | Dicumyl peroxide | 0.03 | 0.03 |
| | (40% active) | | |
| Tri-(2 methoxyethoxy) | Dry Silane coupling agent | 1.6 | 1.21 |
| vinyl silane | (50% active) | | |

Irganox 1010 is available from Ciba, tri-(2 methoxyethoxy) vinyl silane is available from Kettliz, Perkadox BC40-40MB-gr is available from Akzo-Nobel.

### Comparative Example 20

As a comparative example to Example 19, 10% by wt of the ATH was replaced by Claytone™ AF which is an example of an organomontmorillonite.

Preparation of Compositions

A range of such polymer compositions was prepared, using different fillers as detailed below. Filling (compounding) was carried out using a laboratory Banbury mixer of 1.57 litres.

A sheet of filled polymer composition was made in each case, using a twin roll mill set up at 120° C., and plaques were then pressed at 160° C.

Testing

Tensile strength (at peak) and elongation at break were tested using a Monsanto tensometer. Test pieces of he polymer sheets were conditioned for 48 hours at 23° C., 50% relative humidity, prior to testing. The test speed was set up at 100 mm/min.

With the specific exceptions noted here, the test procedures were generally as described above for Examples 1 to 18. In the burning/dripping test (the UL-94, vertical burning test), the sample had a thickness of 1.7-1.9 mm in Example 19 and the number of drips was recorded. Char strength was tested in Example 19 after burning in a small furnace at 900° C., as the force in grams needed to crush the char.

The following studies were carried out:

(A) Flame retardancy, combustion and mechanical properties of polymer compositions containing ATH and various clays at 50:50 wt %. ratio and the effects of particle size, shape and number;

(B) Investigation into the effect of the ATH:clay ratio;

(C) Investigation into the effect of silane.

(A) Flame Retardancy, Combustion and Mechanical Properties of Polymer Compositions Containing ATH and Various Clays at 50:50 wt %. Ratio and the Effects of Particle Size and Shape

Composition Details

The polymer compositions from Table 4 fell into three categories, the details of which are set out in Table 5 below:

TABLE 5

| Formulation | Filler | phr |
|---|---|---|
| 1- ATH control | ATH | 160 |
| 2- 50:50 (wt %) ATH:clay | ATH:clay | 80:80 |
| 3- 10% (wt) by replacement | ATH:Claytone ™ AF | 145:16 |
| organomontmorillonite | | |

The second formulation represents the tested form of the generic composition according to the present invention. The other two formulations are for means of comparison.

The compositions will be referred to in the same way as the clay fillers were in Tables 1a and 1b above and the associated discussion.

Results

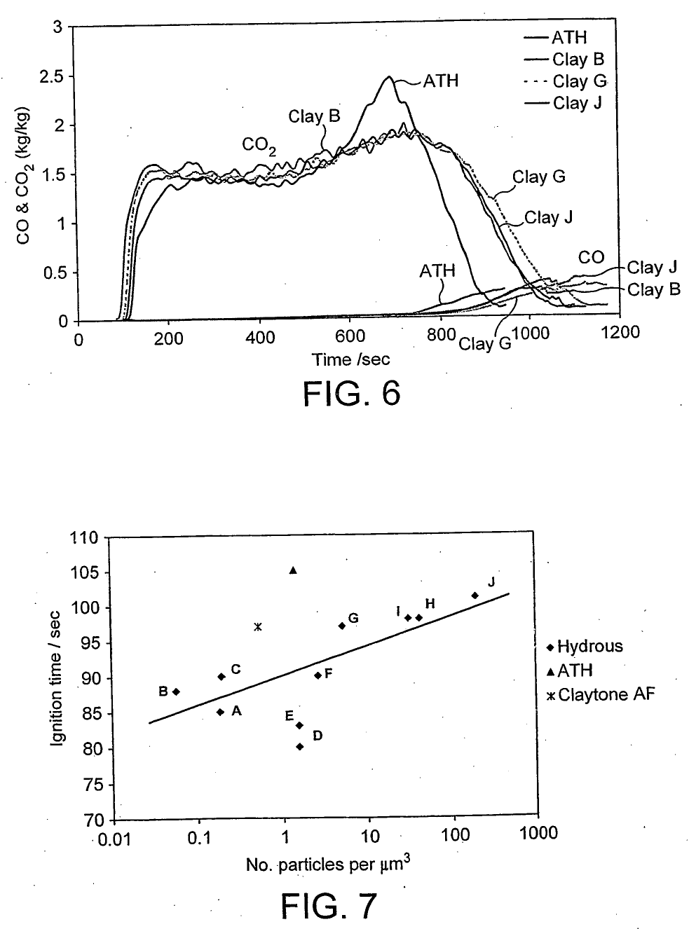

The mechanical and flame/combustion properties of the polymer compositions containing 50:50 wt %. ATH:clay are shown in Tables 6 and 7, and in FIGS. 3 to 7 of the drawings.

TABLE 6

Mechanicals

| | |
|---|---|
| TS/MPa | ε/% |

| | | |
|---|---|---|
| Superfine SF7 | 10.1 | 126 |
| A | 13.1 | 101 |
| B | 11.7 | 117 |
| C | 11.4 | 138 |
| D | 12.1 | 120 |
| E | 12.4 | 106 |
| F | 11.8 | 123 |
| G | 12.6 | 126 |
| H | 11.6 | 178 |
| I | 12.2 | 113 |
| J | 12.5 | 94 |
| K | 10.7 | 97 |
| L | 13.4 | 104 |
| M | 12.6 | 147 |
| Claytone AF | 11 | 595 |
| N -Talc | 12.8 | 105 |

TABLE 7

| | | | | Number | Char | |
|---|---|---|---|---|---|---|
| | | | d50 | particles | strength | Drip |
| | vol % filler | NSF | (μm) | per um³ | (g) | No. |
| Superfine SF7 | 0.3769 | 3 | 0.8 | 1.406 | 0 | ˜50 |
| A | 0.175 | 130 | 1.22 | 0.184 | 80 | 1 |
| B | 0.175 | 70 | 1.8 | 0.057 | 67 | 7 |
| C | 0.175 | 32 | 1.2 | 0.193 | 55 | 7 |
| D | 0.175 | 23 | 0.6 | 1.547 | 77 | 4 |
| E | 0.175 | 28 | 0.6 | 1.547 | 110 | 2 |
| F | 0.175 | 15 | 0.5 | 2.674 | 100 | 2 |
| G | 0.175 | 25 | 0.4 | 5.222 | 77 | 1 |
| H | 0.175 | 35 | 0.2 | 41.78 | 80 | 1 |
| I | 0.175 | 13 | 0.22 | 31.39 | 107 | 0 |
| J | 0.175 | 25 | 0.12 | 193.4 | 113 | 3 |
| K | 0.175 | 3 | 2 | 0.042 | 0 | ˜50 |
| L | 0.175 | 3 | 0.5 | 2.674 | 20 | 7 |
| M | 0.175 | 3 | 0.3 | 12.38 | 85 | 1 |
| Claytone AF | 0.0344 | 1000 | 0.5 | 0.526 | 80 | 0 |
| N - talc | 0.175 | 22 | 1.8 | 0.057 | 53 | 4 |

FIG. 3 illustrates some of the data from Table 7 in graphical form by plotting the mass needed to crush the char (grams) against the Number of clay particles per unit volume (as calculated using the formula stated above) in the polymer composition. It will be seen that, surprisingly, there is a general correlation between char strength and number of particles per unit volume, and that a particularly good char strength, in combination with a good drip resistance (from Table 7) is observed when the number of particles per unit volume is above about 0.01 particle per μm³, (corresponds to 1 particle per 100 μm³).

Mechanical Properties

Generally speaking, the replacement of half the ATH (by wt %) with a clay resulted in a slightly higher tensile strength and similar elongation at break. The formulation with replacement of 10% of ATH with the organoclay Claytone™ AF gave similar tensile strength (11 MPa) and improved elongation.

Fire Behaviour

The dripping and char strength results are also shown in Table 7. Overall, better char correlates with less dripping, but dripping is also influenced by other factors such as melt viscosity and filler dispersion.

Microscopic observation of the ‘good’ chars (e.g. with Clay L) revealed a strong porous network structure whereas the weak char obtained with Clay B seems to comprise a smoother layer of clay and alumina around the surface. Whilst not wishing to be bound by a particular theory, it appears that when the polymer composition burns, a porous network of filler may form around gas bubbles, and a fast formation is needed for good char strength. Fusion between clay particles will be encouraged by increased physical contact, i.e. if there is a large number of small particles per unit volume of the filler.

A good correlation was obtained between the char strength of all compounds and the number of particles in a unit volume (μm³) calculated using d₅₀ (Sedigraph) and the formula shown above—see FIG. 3. Better char strength was achieved with a larger number of particles (note the logarithmic scale in FIG. 3). It is believed that clay particles contact each other quickly when there are a large number of them (it is possible that small and platey may be the best combination). Furthermore, at the right burning temperature, the clay platelet can fuse together and form a strong network. The results shown in FIG. 3 also suggest that the fusion with calcined clay may not be as strong (or occurring as fast) as with hydrous clays. It is possible that the chemical make-up of the clays may also affect char strength, as shown for example by the good char obtained with clay M.

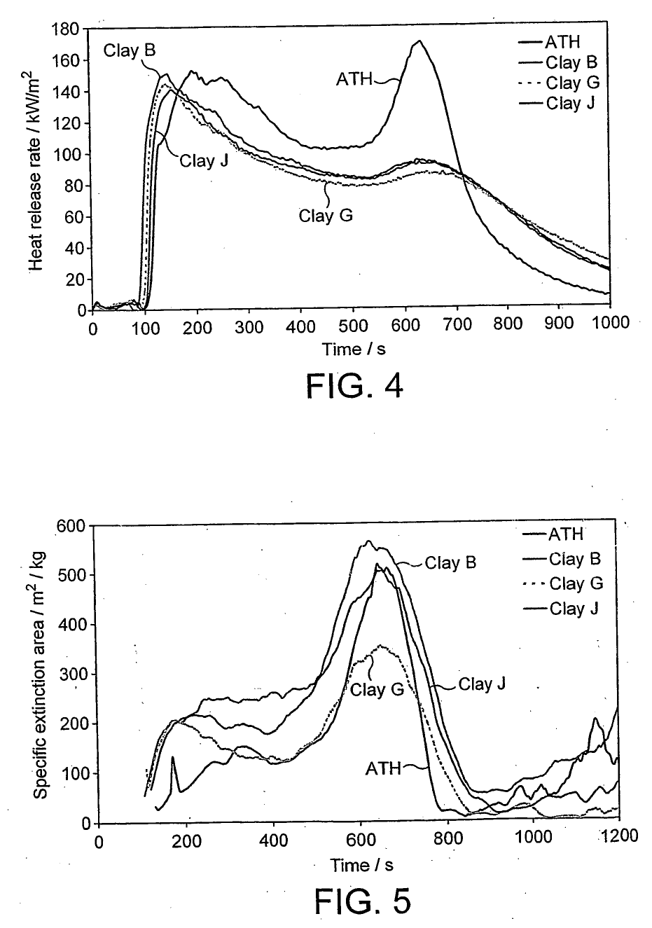

The cone calorimetry results are given in Table 8 below and in FIGS. 4 to 7. The figures are the average of three measurements.

TABLE 8

| | PHRR | IT | FPI | THR |
|---|---|---|---|---|
| | (kW/m²) | (sec) | (s · kW⁻¹m²) | (kJ) |
| Superfine SF7 | 154 | 105 | 0.68 | 822 |
| A | 161 | 85 | 0.53 | 767 |
| B | 151 | 88 | 0.58 | 784 |
| C | 151 | 90 | 0.6 | 686 |
| D | 159 | 80 | 0.5 | 697 |
| E | 158 | 83 | 0.53 | 650 |
| F | 162 | 90 | 0.56 | 655 |
| G | 144 | 97 | 0.67 | 763 |
| H | 165 | 98 | 0.62 | 895 |
| I | 169 | 98 | 0.58 | 714 |
| J | 141 | 101 | 0.71 | 760 |
| Claytone ™ AF | 165 | 97 | 0.59 | 752 |

wherein PHRR is the peak heat release rate (smaller is better), IT is the ignition time (longer is better), THR is the total heat release (smaller is better) from cone calorimetry and FPI the fire performance index (=IT/PHRR, larger is better).

Overall, the 50:50 (by wt %) replacement of ATH with clay resulted in a shorter ignition time (IT), a similar peak heat release rate (PHRR) and smaller total heat release (THR) compared to the ATH control formulation. These gave a similar performance to the 10% replacement of ATH with Claytone™ AF. The comparison between the various clays shows that the ignition time is improved with increasing number of particles, as shown in FIG. 7. The finest clay, Clay J, gave an ignition time close to the ATH control and gave overall the best fire properties. The fire performance index, FPI (IT/PHRR), was slightly better than for the ATH control (balance between ignition time and peak heat release rate).

Overall, the CO₂ and CO emissions of ATH:clay compounds were similar to that of the ATH control. The compounds also gave similar specific extinction area (i.e. the effective optical obscuring area generated by 1 kg of mass loss of specimen). These measurements were carried out using the cone method.

(B) Investigation into the Effect of the ATH:Clay Ratio

Due to the difference in specific gravity of the fillers ATH:clay (2.42 vs. 2.65 g/cc), the volume of polymer present in the composition increases when replacing ATH by clay and the total filler volume decreases. In order to correct for the volume of polymer increasing when replacing ATH by clay, slightly more ATH was added to the ATH:clay polymer. The replacement of ATH with increasing levels of Clay B on a volume basis was carried out so that the resin was always present as 60.45 vol. % and the total filler as 37.69 vol. %. The various compounds are summarised in Table 9 below which gives data for EVA formulations with various ATH:Clay B ratios (replacement on a volume basis). The level of silane was not adjusted for the slight changes in total filler loading.

TABLE 9

| Simplified | ATH:clay after | Corresponding |
|---|---|---|
| ATH:clay | volume correction | phr ATH:clay |
| 100:0 | 100:0 | 160:0 |
| 75:25 | 77.17:36 | 123.47:40 |
| 60:40 | 63.48:40 | 101.56:64 |
| 50:50 | 54.34:50 | 86.94:80 |
| 40:60 | 45.21:60 | 72.34:96 |
| 25:75 | 31.51:75 | 50.42:120 |
| 0:100 | 0:109.5 | 0:175.21 |

Mechanical and Fire Properties

Table 10 below shows the mechanical and burning properties as a function of ATH:Clay B ratio (by volume).

TABLE 10

| | | | | UL-94 | | char | | | |
|---|---|---|---|---|---|---|---|---|---|
| | Vol % | TS | | burning | drip | strength | IT | PHRR | |
| | ATH | (MPa) | ε/% | time (s) | no. | (g) | (s) | kW/m² | LOI |
| 100 ATH | 37.69 | 9.6 (0.2) | 180 (19) | 147 | many | — | 152 | 149 | 33.5 |
| 75:25 | 29.09 | 10.2 (0.1) | 158 (31) | 108 | 20 | 20 | 147 | 135 | 30 |
| 60:40 | 23.92 | 10.5 (0.1) | 180 (19) | 95 | 12 | 40 | 142 | 145 | 27 |
| 50:50 | 20.48 | 11 (0.1) | 150 (21) | 93 | 7 | 25 | 141 | 121 | 26 |
| 40:60 | 17.04 | 10.5 (0.2) | 201 (54) | 89 | 14 | 10 | 130 | 149 | 25.5 |
| 25:75 | 11.88 | 10.5 (0.1) | 174 (33) | 83 | 10 | 35 | 140 | 142 | 23.5 |
| 100 clay B | 0 | 11.1 (0.5) | 405 (100) | 47 | many | 15 | 130 | 217 | 21 |

In terms of mechanical properties, all ATH:Clay B compositions showed similar tensile strength (between 10.2 and 11 MPa) and elongation at break (around 150-200%). The best elongation was found for the composition containing clay only (400%).

In terms of fire behaviour, the limiting oxygen index decreased (hence was worse) with decreasing ATH content in the composition. This also agreed with the faster burning in the UL-94 vertical burning test and the shorter ignition time on cone calorimetry when more ATH was replaced with clay. However, the best behaviour for dripping was obtained for the 50:50 blend. This might be due to the optimum balance between the cooling behaviour of ATH and the char formation with clay.

Some of the chars obtained after burning at 900° C. were difficult to remove from the ceramic dish without breaking them. This had the effect that the char strength could not be assessed accurately. The best char was obtained for the 60:40 ATH:Clay B compound. However, the compositions at higher clay content also had strong chars, as shown in Table 10. These clay compositions also gave good peak heat release rate compared to the ATH control. These results show that there is a range of replacement of ATH possible.

(C) Investigation into the Effect of Silane

The peroxide level was set to 0.03 phr of active peroxide (0.075 total phr) and a range of silane concentrations was investigated. The compounds were 50:50 ATH:Clay G (wt %. basis) and the silane levels are recorded below in Table 11, which shows silane levels (by wt %) used in 50:50 by weight % ATH:Clay G formulation.

TABLE 11

| wt. % silane on | | | |
|---|---|---|---|
| filler (ATH + clay) | Active phr | Total phr | Active wt. % |
| 0.5 | 0.8 | 1.6 | 0.61 |
| 1 | 1.6 | 3.2 | 1.21 |
| 1.5 | 2.4 | 4.8 | 1.82 |
| 2 | 3.2 | 6.4 | 2.42 |

The effect of silane level on the mechanical and fire results are summarised in Table 12 below, which shows silane levels (by wt %) used in 50:50 by weight % ATH:Clay G formulation.

TABLE 12

| | Tensile | | | |
|---|---|---|---|---|
| | strength/ | Elongation | 1^{st} burn | Number of |
| Filler Clay G:ATH | MPa | at break/% | time/s | drips |
| 0.5% silane | 12.4 (0.1) | 165 (16) | 79 (11) | 3 |
| 1% silane | 12.6 (0.1) | 131 (9) | 88 (20) | 1 |
| 1.5% silane | 12.4 (0.1) | 129 (7) | 80 (7) | 1 |
| 2% silane | 12.6 (0.2) | 134 (14) | 71 (7) | 1 |

All of the compounds gave similar mechanical properties.

On the UL-94 vertical burning test, the slowest burning composition was that using the 1% silane, which dripped and ignited the cotton once after the flame had just reached the top of the sample. The 1.5% and 2% silane compositions behaved in a similar way, only dripping once, but they burned more rapidly. This may be due to the excess silane in the system, resulting in more organics to be burnt.

The 0.5% silane composition produced the least favourable results, dripping an average three times during the test period, and also burning more rapidly than the 1% compound. The optimum silane concentration is therefore about 1% active weight on the total filler since it provides the best fire behaviour.

Discussion of All the Examples

Referring to the results shown in FIGS. 1 and 2, there is little difference in the viscosity of all the compositions. The graph lines for the CLDO compositions are below the graph lines for the Escorene compositions, showing that the CLDO compositions have generally lower viscosity than the Escorene compositions. This is in agreement with the viscosity of the base polymers, as the CLDO has lower viscosity than the EVA polymer.

Viscosity measurements of the polymers composition with 61% clay and 2% plasticiser are given in FIG. 1(a). Again, there is little if any difference in the viscosity of the composition as a result of inclusion of Clay A. This indicates that the ATH could be replaced in a large percentage with the clay without affecting the production speed of the polymer composition, e.g. in an electrical cable manufacturing process.

The viscosity of the compositions with 50ATH: 50 Clay A with total filler loading of 61% was also measured and the data are given in FIG. 2 of the drawings. It can be concluded that there is little adverse effect on viscosity by partially substituting ATH with Clay A.

All the compositions of the Examples 1-18 (i.e. according to the present invention) produced a char in the form of a shell, a significant improvement on the ash produced when ATH alone was used as filler.

Indeed, as shown in Tables 2 and 3, it is advantageous for the clay to be present with ATH. The clay may suitably be present in an amount greater than the ATH. At a clay loading equal to and above 50:50 Clay A:ATH, the clay/ATH filler stopped dripping of the molten CLDO polymer. 100% clay was required before dripping of the Escorene polymer was stopped. The incorporation of relatively large amounts of clay into the filler in partial substitution for the ATH does not significantly impair the other fire and mechanical properties of the polymer compositions, compared with the polymer filled with ATH alone.

Comparative Examples C2 and C4 used a mixture of Claytone AF organoclay and ATH (5:95). This is an organomontmorillonite clay of the type described in WO-A-01/46307. The clay compounded well with base polymers and the mechanical properties are given in Tables 2 and 3. While the elongation of these compositions was quite high, the tensile strength was significantly poorer than the compositions of the present invention, and poorer even than the comparison compositions filled with ATH alone.

As shown in FIG. 3, the effect of increasing the number of clay particles in a given volume (typically via increasing shape factor and/or decreasing the diameter of the clay disk) has the effect of increasing the char strength. As shown in Table 6, this advantage can be combined with a very low tendency of the filled composition to drip during combustion. The effect of increasing the number of clay particles in a given volume also results in an improvement in the ignition behaviour, i.e. increased ignition time as shown in FIG. 7. The 50:50 (by wt %) clay:ATH formulations of the present invention compare well in terms of fire performance with a 10:90 (by wt %) mix of Claytone™ AF organoclay:ATH.

Conclusions

The use of a particulate clay in accordance with the present invention as a filler component in polymer compositions, in effective amounts and optionally in the presence of co-additives, offers significant cost and technical advantages in the formulation of flame retardant polymer compositions having generally acceptable char strength, optionally together with good drip resistance and other properties.

The present invention has been described broadly and without limitation to specific embodiments. Variations and modifications as will be readily apparent to those of ordinary skill in this art are intended to be included within the scope of this application and subsequent patent(s).

1-40. (canceled)

41. A flame retardant polymer composition comprising a polymer and a particulate filler material distributed in the polymer composition at a particle number per unit volume of at least about 1 particle per 100 μm³ wherein the particulate filler material comprises a clay mineral that is not an organomontmorillonite.

42. The composition according to claim 41, wherein the particle number per unit volume in the polymer composition is at least about 10 particles per 100 μm³.

43. The composition according to claim 41, wherein the clay mineral is chosen from a hydrous kaolin clay, a partially calcined kaolin clay and a fully calcined kaolin clay.

44. The composition according to claim 41, wherein the clay mineral comprises a talc.

45. The composition according to claim 41, wherein the clay mineral is chosen from a hydrous kaolin, a partially calcined kaolin, a fully calcined kaolin, a talc, and mixtures thereof.

46. The composition according to claim 43, wherein the clay mineral has a mean equivalent particle diameter less than or equal to about 4 μm and a particle shape factor which is greater than about 10.

47. The composition according to claim 46, wherein the mean equivalent particle diameter is less than or equal to about 3 μm.

48. The composition according to claim 46, wherein the mean equivalent particle diameter ranges from about 0.1 to about 2 μm.

49. The composition according to claim 46, wherein the mean equivalent particle diameter ranges from about 0.5 to about 2 μm.

50. The composition according to claim 46, wherein the mean equivalent particle diameter ranges from about 0.5 to about 1.5 μm.

51. The composition according to claim 46, wherein the shape factor ranges from about 10 to about 150.

52. The composition according to 46, wherein the shape factor is greater than about 30.

53. The compositions according to claim 46, wherein the shape factor is less than about 150.

54. The composition according to claim 41, further comprising at least one flame retardant component.

55. The composition according to claim 41, further comprising at least one non-kaolin flame retardant component.

56. The composition according to claim 54, wherein the at least one flame retardant component is chosen from phosphorous-containing compounds, boron-containing compounds, metal salts, metal oxides, metal hydroxides and hydrates thereof, organoclays, and halogenated hydrocarbons.

57. The composition according to claim 56, wherein the organoclays are chosen from ion-exchange and other modified organoclays.

58. The composition according to claim 56, wherein the at least one flame retardant component is chosen from alumina trihydrate, boric acid, and a metal borate.

59. The composition according to claim 41, wherein the clay mineral is present in an amount of at least about 50% of the total weight of the composition.

60. The composition according to claim 41, wherein the polymer comprises a thermoplastic polymer.

61. The composition according to claim 41, wherein the polymer comprises a thermoset polymer.

62. The composition according to claim 41, wherein the polymer is chosen from polyolefins, polycarbonates, polystyrenes, polyesters, acrylonitrile-butadiene-styrene copolymers, nylons, polyurethanes, and ethylene-vinyl acetates.

63. The composition according to claim 62, wherein the polyolefins comprise polyethylene or polypropylene.

64. The composition according to claim 41, further comprising a silane.

65. An article comprising the flame retardant polymer composition according to claim 41.

66. A sheath for an electrical product comprising the flame retardant polymer composition according to claim 41.

67. A flame retardant polymer composition comprising a polymer and a particulate kaolin clay having a mean equivalent particle diameter less than or equal to about 4 μm and a particle shape factor greater than about 10.

68. The composition according to claim 67, wherein the mean equivalent particle diameter is less than or equal to about 3 μm.

69. The composition according to claim 67, wherein the mean equivalent particle diameter ranges from about 0.1 to about 2 μm.

70. The composition according to claim 67, wherein the mean equivalent particle diameter ranges from about 0.5 to about 2 μm.

71. The composition according to claim 67, wherein the mean equivalent particle diameter ranges from 0.5 to about 1.5 μm.

72. The composition according to claim 67, wherein the shape factor ranges from about 10 to about 150.

73. The composition according to 67, wherein the shape factor is greater than about 30.

74. The compositions according to claim 67, wherein the shape factor is less than about 150.

75. The composition according to claim 67, further comprising at least one flame retardant component.

76. The composition according to claim 67, further comprising at least one non-kaolin flame retardant component.

77. The composition according to claim 75, wherein the at least one flame retardant component is chosen from phosphorous-containing compounds, boron-containing compounds, metal salts, metal oxides, metal hydroxides and hydrates thereof, organoclays, and halogenated hydrocarbons.

78. The composition according to claim 77, wherein the organoclays are chosen from ion-exchanged and other modified organoclays.

79. The composition according to claim 77, wherein the at least one flame retardant component is chosen from alumina trihydrate, boric acid, and a metal borate.

80. The composition according to claim 67, wherein the particulate kaolin clay is present in an amount of at least about 50% of the total weight of the composition.

81. The composition according to claim 67, wherein the polymer comprises a thermoplastic polymer.

82. The composition according to claim 67, wherein the polymer comprises a thermoset polymer.

83. The composition according to claim 67, wherein the polymer is chosen from polyolefins, polycarbonates, polystyrenes, polyesters, acrylonitrile-butadiene-styrene copolymers, nylons, polyurethanes, and ethylene-vinyl acetates.

84. The composition according to claim 83, wherein the polyolefins comprise polyethylene or polypropylene.

85. The composition according to claim 67, further comprising a silane.

86. An article comprising the flame retardant polymer composition according to claim 67.

87. A sheath for an electrical product comprising the flame retardant polymer composition according to claim 67.

88. A particulate filler material for a flame retardant polymer composition comprising at least one particulate non-kaolin flame retardant component and at least one clay mineral comprising a particulate kaolin clay, the particulate kaolin clay having a mean equivalent particle diameter less than or equal to about 4 μm and a particle shape factor greater than about 10.

89. The filler material according to claim 88, wherein the shape factor is greater than about 30.

90. The filler material according to claim 88, wherein the at least one non-kaolin flame retardant component is chosen from phosphorous-containing compounds, boron-containing compounds, metal salts, metal oxides, metal hydroxides and hydrates thereof, organoclays, and halogenated hydrocarbons.

91. The filler material according to claim 90, wherein the organoclays are chosen from ion-exchanged and other modified organoclays.

92. The filler material according to claim 90, wherein the metal hydrates comprise alumina trihydrate, with less than about 10% by weight of other components, and said filler material optionally further comprises at least one other non-kaolin flame retardant component.

93. The filler material according to claim 88, wherein the particulate kaolin clay is chosen from a hydrous kaolin, a partially calcined kaolin, and a fully calcined kaolin.

94. The filler material according to claim 88, wherein the at least one clay mineral further comprises a talc.

95. The filler material according to claim 88, wherein the at least one non-kaolin clay has a mean equivalent particle diameter less than or equal to about 4 μm and a particle shape factor which is greater than about 10.

96. The filler material according to claim 88, wherein the mean equivalent particle diameter is less than or equal to about 3 μm.

97. The filler material according to claim 88, wherein the mean equivalent particle diameter ranges from about 0.1 to about 2 μm.

98. The filler material according to claim 88, wherein the mean equivalent particle diameter ranges from about 0.5 to about 2 μm.

99. The filler material according to claim 88, wherein the mean equivalent particle diameter ranges from about 0.5 to about 1.5 μm.

100. The filler material according to claim 88, wherein the shape factor ranges from about 10 to about 150.

101. The filler material according to claim 88, wherein the shape factor is greater than about 30.

102. The filler material according to claim 88, further comprising at least one polymer or precursor thereof in a form chosen from liquid and particulate solid.

103. An article comprising the particulate filler material according to claim 88.

104. A sheath for an electrical product comprising the particulate filler material according to claim 88.

105. A particulate filler material for a flame retardant polymer composition comprising at least one particulate non-clay mineral flame retardant component and at least one particulate non-kaolin clay mineral, wherein the non-kaolin clay mineral has a mean equivalent particle diameter less than or equal to about 4 μm and a particle shape factor which is greater than about 10.

106. The filler material according to claim 105, wherein the at least one non-clay mineral component is chosen from phosphorous-containing compounds, boron-containing compounds, metal salts, metal hydroxides, metal oxides and hydrates thereof, and halogenated hydrocarbons.

107. The filler material according to claim 106, wherein the metal hydrates comprise alumina trihydrate, with less than about 10% by weight of other components, and said filler material optionally further comprises at least one other particulate non-clay mineral flame retardant component.

108. The filler material according to claim 105, wherein the at least one particulate non-kaolin clay mineral comprises a talc.

109. The filler material according to claim 105, further comprising an organoclay.

110. The filler material according to claim 105, further comprising at least one polymer or precursor thereof in a form chosen from liquid and particulate solid.

111. An article comprising the particulate filler material according to claim 104.

112. A sheath for an electrical product comprising the particulate filler material according to claim 104.

113. A method for forming a flame retardant polymer composition comprising (1) mixing at least one polymer and at least one particulate filler material comprising a particulate clay mineral and (2) distributing in the polymer, the particulate filler material in a particle number per unit volume of at least about 1 particle per 100 μm³ wherein the clay mineral is not an organomontmorillonite.
